(19) United States
(12) Patent Application Publication
(10) Pub. No.: US 2016/0189109 A1
(43) Pub. Date: Jun. 30, 2016

(54) ADAPTIVE EVENT SCHEDULING

(71) Applicant: Apollo Education Group, Inc., Phoenix, AZ (US)

(72) Inventors: David Le, San Jose, CA (US); Mei-chiao Lin, Cupertino, CA (US); Sravanthi Deshmukh, Milpitas, CA (US); Ted Wong, San Francisco, CA (US); Manish Upendran, San Francisco, CA (US); Isabel George, Foster City, CA (US); Shane Lunceford, San Jose, CA (US)

(21) Appl. No.: 14/584,113

(22) Filed: Dec. 29, 2014

(51) Int. Cl. G06Q 10/10; H04L 29/08

(52) U.S. Cl. CPC G06Q 10/1095; H04L 67/306

(57) ABSTRACT

A method and system for adaptive event scheduling are provided. A first start time and a first duration are automatically selected for a first calendar event. The first calendar event is for a first learning activity of the course. Insertion of the first calendar event is caused, at the first start time and with the first duration, into an electronic calendar associated with a user participating in a course. Behavior of the user relative to performance of the first learning activity is monitored. Based at least in part on the behavior, a second start time and a second duration are automatically selected for a second calendar event. The second calendar event is for a second learning activity of the course. Insertion of the second calendar event is caused, at the second start time and with the second duration, into the electronic calendar.

### FIELD OF THE INVENTION

Embodiments of the invention described herein relate generally to adaptive computer systems, and, more specifically, to techniques for adaptive event scheduling.

### BACKGROUND

Electronic calendars are used for time management. Calendar data that is used by electronic calendars may be stored and/or accessed via online calendar services. Typically, an online calendar user schedules activities by manually adding events into an interface generated for an electronic calendar. In addition to manually added events, some systems support the automated detection of potential calendar event parameters in text, such as e-mail, such as by scanning for date, time and/or duration information in text. Automatically detecting potential calendar event parameters facilitates the creation of a calendar event by allowing a user to choose whether to generate a calendar event based on the exact parameters detected. Synchronization services also exist for copying exact event data between different online calendars. Some synchronization services are configured to synchronize event data between electronic calendars maintained by different third party electronic calendar providers. Synchronization of calendars causes the automatic creation of calendar events on one calendar based on previously-entered events in another calendar. Such synchronization-created events are limited to exact event data that is found in text or in the calendar data of another calendar.

When a user manually creates a calendar event for an activity, the user must know or estimate the actual duration to schedule for the activity. When the timing of the activity is within the control of the user, the user must also consider other factors while manually scheduling the activity, such as his general availability, an optimum time of day to perform the activity, and relationships between the activity and other activities that are currently scheduled or must be scheduled.

In a learning environment, a participant in a course must typically perform learning activities related to the course. Although a syllabus may be provided, the user typically has control over when the user actually does the required learning activities. This may include estimating the duration for the learning activities and manually entering corresponding events into an online calendar of his choice. If the user does not keep up with his selected schedule, or if the duration of one or more manually determined events is inaccurate, the user must potentially reschedule all the following learning activities of the course. When the user does not properly take into account such factors related to scheduling the learning events corresponding to the course, the user may fall behind, inadequately retain information presented in the course, or otherwise perform poorly in the course.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that illustrates an embodiment of an example system architecture;

FIG. 2 is a flow diagram that illustrates an embodiment of a process for adaptive event scheduling for related activities;

FIG. 3 is a flow diagram that illustrates an embodiment of a process for maintaining a behavior profile and using the behavior profile for adaptive event scheduling for related learning activities; and

FIG. 4 illustrates a computer system upon which one or more embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for automatically determining, for a user that is taking a course, start times and durations of activities required by the course, and automatically inserting those activities into the user's calendar. Activities that the user has not yet performed may be related to activities that the user has already performed. In one embodiment, the start time and duration of those future activities are automatically determined based on the behavior of the user relative to the performance of the user's completed activities. In this manner, the adaptively scheduled activities are adaptively scheduled based on actual user patterns and/or outcomes.

After the start time and duration of the not-yet-performed activities of the user are determined, the not-yet-performed activities are automatically inserted and/or updated in an electronic calendar of the user. Adaptive event scheduling based on personal performance and/or outcomes helps improve performance, personalize user experience, and increase user engagement. For example, in the context of a learning platform for students enrolled in a selection of courses, adaptive event scheduling may be based on inputs including, but not limited to:
behavior data of the user relative to learning activities of a current course,
behavior data of the user relative to learning activities of other courses and historical courses,
behavior data of other users,
external calendar event data of the user,
other external timing factors,
user preferences, and
course constraints.

The following description includes numerous examples where adaptive event scheduling is in an education environment. For example, examples are described for scheduling learning activities for an online course, and for monitoring behavior relative to the performance of learning activities, such as reading assignments, viewing educational media such as but not limited to text, audio and/or video media, homework assignments, other assignments, individual projects, group projects, live or recorded lectures, other live or recorded sessions, reviews, quizzes, other examinations, interactive learning activities, and other learning activities. However, embodiments are not limited to the education environment. Embodiments are applicable to adaptive event scheduling for any set of activities.

### Electronic Calendar Systems

The techniques described herein are not limited to the use of any particular electronic calendar system. For example, the techniques described herein may be used in conjunction with an electronic calendar system provided by a third party, such as Microsoft Outlook and Exchange, Gmail Calendar, Yahoo Calendar, iOS Calendar, Evernote, or other third party calendar services. Alternatively, the techniques may be used in conjunction with an electronic calendaring system provided by the same party that is offering the course. In such an embodiment, the mechanism for automatically determining the start time and duration of course activities may be built in to the electronic calendaring system.

For the purpose of explanation, embodiments shall be described herein in which the electronic calendar system into which course activities are automatically schedules is provided by a different party than the party that is providing the automatically scheduling service. However, the techniques described herein are not limited to such an embodiment.

### System Overview

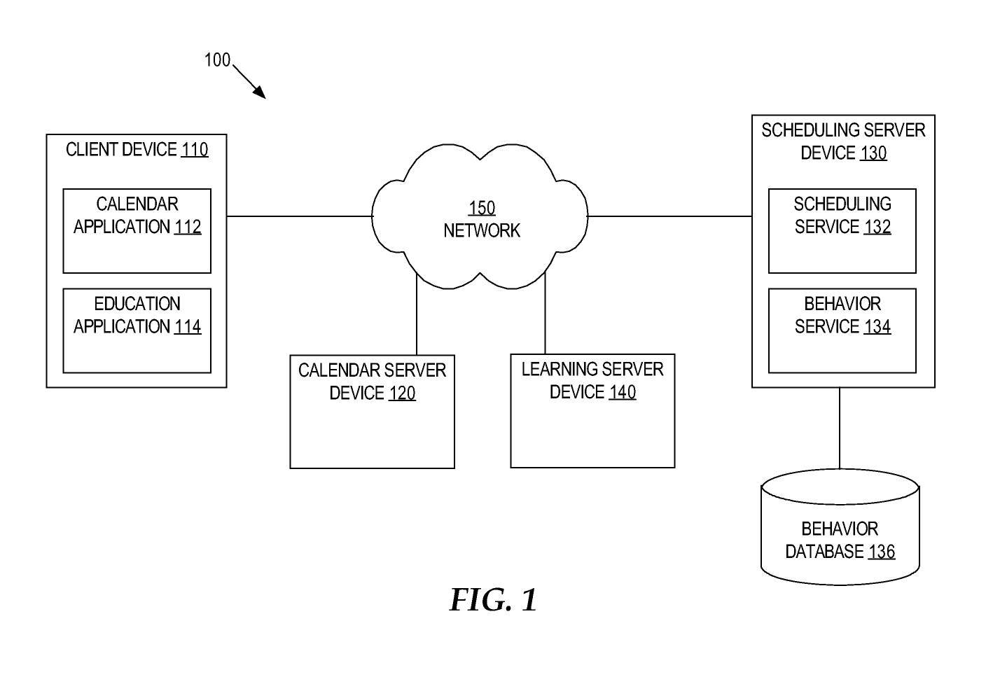

FIG. 1 is a block diagram of a system 100 for automatically scheduling course activities in an electronic calendaring system, according to an embodiment. System 100 includes a client device 110, a calendar server device 120, a learning server device 140, a scheduling server device 130, a network 150, and a behavior database 136. Each of these components of the system 100 shall be described in greater detail hereafter.

### Client Device

Client device 110 generally represents a device used by a user that is taking a course, where the course has activities that the user of client device 110 has to perform. Although one client device 110 is shown in system 100, system 100 may support a plurality of client devices 110. That is, each user can have multiple client devices, and the system architecture may support any number of users.

Client device 110 is communicatively coupled to network 150, such as a local area network, the Internet, or any other computer network. Client device 110 is configured to communicate with at least calendar server device 120 and scheduling server device 130 over network 150. Client device 110 may be implemented by any type of computing device, including but not limited to workstations, personal computers, laptop computers, personal digital assistants (PDAs), tablet devices, mobile devices such as smart phones, and any other computing devices.

In the illustrated embodiment, client device 110 is executing a calendar application 112, which displays a calendar interface to the user. Specifically, the calendar interface displays events based on electronic calendar data of the user. The events displayed on the calendar interface include calendar events for activities that are automatically added by scheduling server device 130. For example, the electronic calendar may be displayed in a web browser, a web application, a mobile application, and/or any other application configured to display electronic calendar data.

In one embodiment, client device 110 is configured communicate with learning server device 140 over network 150. For example, client device 110 may be configured to display a graphical user interface associated with one or more learning activities provided and/or monitored by learning server device 140. Education application 114 generally represents the client-side application through which the user performs course activities. Education application 114 may be, for example, the learning interface may be displayed in a web browser, a web application, a mobile application, and/or any other application configured to display a learning interface.

### Calendar Server Device

Calendar server device 120 generally represents one or more computing devices that are executing the server-side component of the client-server electronic calendaring system to which calendar application 112 belongs. Although one calendar server device 120 is shown in system 100, system 100 may support a plurality of calendar server devices 120. Calendar server device 120 is communicatively coupled to network 150. Calendar server device 120 is configured to communicate with at least client device 110 and scheduling server device 130, to provide a user's calendar event data to calendar application 112 and/or accept changes from calendar application 112 to the user's calendar event data. Calendar server device 120 may be implemented by any type of computing device, including but not limited to workstations, server computers, computing devices located in a cloud environment, and any other computing devices. Different users may use different calendar providers, and therefore have their calendar data maintained by calendar server devices managed by different providers.

### Scheduling Server Device

Scheduling server device 130 generally represents one or more computing devices that are executing the scheduling service 132 that automatically schedules course activities on the user's calendar. Although one scheduling server device 130 is shown in system 100, system 100 may support a plurality of scheduling server devices 130. Scheduling server device 130 is communicatively coupled to network 150. Scheduling server device 130 is configured to communicate with at least client device 110 and calendar server device 120, to obtain a user's calendar event data, insert calendar events, delete calendar events, or change calendar events in the user's calendar event data. Scheduling server device 130 may be implemented by any type of computing device, including but not limited to workstations, server computers, computing devices located in a cloud environment, and any other computing devices.

As mentioned above, the electronic calendar of a user may be provided by a third party, or by the same entity as the scheduling server device 130. Thus, although calendar server device 120 and scheduling server device 130 are shown as separate devices, in one embodiment, calendar server device 120 and scheduling server device 130 are the same device or are a set of devices that belong to the same local area network.

In one embodiment, scheduling server device 130 communicates with a third party calendar service on calendar server device 120 via one or more Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication.

### Scheduling Service

As shown, scheduling server device 130 is configured with scheduling service 132 and behavior service 134. Scheduling service 132 is configured to adaptively schedule one or more events corresponding to one or more activities based on user data, including user calendar data and/or user behavior data. For example, scheduling service 132 may be configured to insert one or more events into an electronic calendar associated with a user. The process of adaptively scheduling learning activities for a user that is enrolled in a particular course shall be describe in greater detail hereafter.

### Behavior Service

Behavior service 134 is configured to monitor user behavior relative to the performance of one or more activities. As shall be described in greater detail hereafter, the behavior of the user, relative to the performance of the one or more activities, is used to schedule calendar events for future activities. In one embodiment, behavior service 134 updates a behavior profile of the user based on newly captured behavior data corresponding to completed learning activities. In one embodiment, behavior service 134 feed the user's behavior data to one or more learning algorithms and/or artificial intelligence techniques to determine patterns in the user's behavior. Behavior service 134 may also use non-learning procedures and heuristics to identify such patterns.

Behavior service 134 may maintain behavior data for a user for a current course, a set of current courses or a set of current and historical courses. In one embodiment, behavior service 134 maintains a behavior profile for a user for all courses associated with the user, such as all courses the user participates in as part of an educational program. The behavior profile of the user may be stored in a database, such as behavior database 136. In one embodiment, behavior service 134 maintains one or more behavior profiles for one or more users, which may be stored in behavior database 136.

### Interactions Between Components of the System

According to one embodiment, the various components of system 100 may communicate with in other in any of a variety of ways. For example, the components may be designed to respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication. Those communications may, for example, may be initiated by client device 110, calendar server device 120, learning server device 140, or from one of the other services 132-134. Further, the various components of system 100 may respond to call and/or requests by sending one or more of the following over network 150:
information via HTTP, HTTPS, SMTP, etc.;
XML data;
SOAP messages;
API calls.

### Behavior Database

Scheduling server device 130 is communicatively coupled to behavior database 136. Behavior database 136 stores behavior data relative to performance of one or more activities by one or more users. In one embodiment, behavior database 136 stores a plurality of behavior profiles for a plurality of users relative to the performance of a plurality of activities. Behavior database 136 may reside in any type of storage, including volatile and non-volatile storage including random access memory (RAM), one or more hard or floppy disks, or main memory, and may be implemented by multiple logical databases. The storage on which behavior database 136 resides may be external or internal to scheduling server device 130.

### Learning Server Device

Learning server device 140 generally represents one or more computing devices that execute instructions to provide learning activities of a course to the client devices of the users that are in the course. As mentioned above, such learning activities may be performed by the user of client device 110 using education application 114. Although one learning server device 140 is shown in system 100, system 100 may support a plurality of learning server devices 140. Learning server device 140 is communicatively coupled to network 150.

Learning server device 140 is configured to communicate with at least client device 110, such as to provide data corresponding to one or more learning activities. In one embodiment, after the user has computed a course activity, learning server device 140 is configured to communicate with scheduling server device 130 to provide data corresponding to the performance of a learning activity by a user. Learning server device 140 may be implemented by any type of computing device, including but not limited to workstations, server computers, computing devices located in a cloud environment, and any other computing devices. Although learning server device 140 and scheduling server device 130 are shown as separate devices, in one embodiment, learning server device 140 and scheduling server device 130 is the same device or belong to the same local area network.

In one embodiment, the education application 114 running on client device 110, such as a web application, a mobile application, and/or any other application, communicates with learning server device 140 to carry out at least a portion of a learning activity. For example, the education application 114 may display a document or other educational media, including text, audio and/or video. Content related to one or more learning activities may be provided by learning service device 140, either directly (e.g. from a local database) or indirectly (e.g. by linking the user device to another server device). In one embodiment, multiple user devices may be used to access the learning activities. For example, a user may perform a reading activity from an e-reader device, participate in a live discussion on a web conference from his laptop computer, and perform an interactive learning activity over a touchscreen-enabled tablet device.

### Learning Activities

As used herein, the term “activity” refers to any event that takes a duration of time to complete. Thus, a calendar event may be created for any activity. Hereafter, the timing of a calendar event is represented using a start time and a duration. However, even when timing of a calendar event is represented using a start time and an end time, the calendar still has a duration. Thus, determining a start time and an end time for a calendar event is equivalent to determining a start time and a duration.

In one embodiment, learning server device 140 and scheduling server device 130 cooperate to provide adaptive event scheduling to learning activities. As used herein, the term “learning activity” refers to any educational activity. Examples of learning activities include, but are not limited to:
viewing text,
listening to audio
watching video media,
preparing homework assignments, other assignments, individual projects, group projects,
attending live or recorded lectures, other live or recorded sessions,
taking reviews, quizzes, other examinations,
engaging in interactive learning activities, and other learning activities.

### Dependencies Between Learning Activities

The techniques described herein may be used to perform adaptive event scheduling for any set of activities that include dependencies between activities and/or similarities between activities. An example of a dependency is when a dependent activity must be performed after another activity, such as when a student must perform one or more prerequisite learning activities (e.g. read a chapter of a textbook) before a follow-up learning activity (e.g. taking a test for that chapter). For example, a reading assignment and a homework assignment may be prerequisite learning activities before taking a quiz. In this case, the reading assignment and homework assignment must be performed before taking the quiz, so taking the quiz is “dependent” on both the reading assignment and the homework assignment. Another example of a dependency is when members of a group must finish individual tasks before performing one or more group tasks, such as completing a reading assignment before a group session.

The learning activities of a course may have dependencies on other learning activities of the course. For example, it may be required or recommended that at least some of the learning activities of a course may be performed in a prescribed order relative to each other and/or relative to a suggested schedule. A course may also include mandatory and/or optional learning assignments.

### Similarities Between Learning Activities

An activity may also be similar to another activity. For example, two or more activities may share the same subject matter, difficulty, skill level required, complexity, expected duration, or any other classification. As shall be described in greater detail below, similarities between learning activities may be a factor, used by scheduling service 132, to determine when to schedule learning activities of a particular course for a particular user that is taking the particular course.

### Course Data

The data associated with a course is referred to herein as “course data”. Course data may include, for example, data that indicates learning activities, scheduling information including order and other dependencies, and other course information. The course data may further include behavior data of historical users for one or more learning activities, which may be used to generate default or baseline information, such as but not limited to a default duration and/or assessment score information. As shall be described in greater detail hereafter, such course data may be stored for access by a scheduling server device 130, such as in behavior database 136. The scheduling server device 130 uses the course data for adaptive event scheduling of a particular learning activity by applying a user's learning velocity metric to the particular learning activity. Learning velocity metrics will be described in greater detail hereafter.

### Timing of Learning Activities

Learning activities may have a fixed time and duration, such but not limited to as a live lecture, another live session, or an exam. Other learning activities may be performed at a flexible time and/or duration, such as but not limited to a reading assignment, viewing educational media, a homework assignment, another assignment, an individual project, a group project, a recorded lectures, another recorded session, a review, a quiz or another assessment. Learning activities that have a flexible time and/or duration may nevertheless have additional constraints on timing and/or duration, such as a course schedule, the schedule of other group members, and other constraints.

### Automatically Scheduling Learning Activities

In one embodiment, scheduling service 132 automatically schedules a plurality of learning activities in a user's calendar. Depending on the course, some learning activities of the course may be:
manually scheduled by the course faculty
manually scheduled by the user who takes the course
automatically scheduled based on constraints specified for the course
automatically scheduled based on any number of additional factors.

For example, learning activities that must or should be completed within a time window (e.g. next two weeks) may be automatically scheduled based on those constraints. Alternatively and/or in addition, learning activities that are mandatory rather than automatic may be automatically scheduled. Alternatively and/or in addition, learning activities that have a fixed time and duration may be automatically scheduled.

Automatically scheduling a learning activity comprises automatically determining a start time and a duration for a calendar event corresponding to the learning activity and causing the calendar event to be inserted into the user's calendar. As shall be described in detail hereafter, scheduling service 132 automatically determines a start time and duration of learning activities for a target user based on one or more of the following factors:
learning activity classifications
behavior data captured from the target user
calendar-interaction behavior of the target user
existing behavior data for the target user
external event data of the target user
behavior data of other users

Each of these factors, and how each of these factors is used by scheduling service to automatically schedule learning activities of a course, shall be described in greater detail hereafter.

### Learning Activity Classifications

In one embodiment, learning activities are classified into two or more classifications. The classification to which a learning activity is assigned may be based on subject matter (e.g. math or social studies) of the learning activity, difficulty of the learning activity, skill level required by the learning activity, complexity of the learning activity, expected duration of the learning activity, or any other characteristic of the learning activity. The classifications assigned to a learning activity, in combination with the performance data collected about the learning activity, may be used by scheduling service 132 to adapt the time and/or duration of a later learning activity with a similar classification. For example, if the performance information collected by behavior service 134 from education application 114 indicates that the user of client device 110 tends to spend longer on learning activities that are “difficult” in the subject of “math”, then scheduling service 132 may extend the duration of a future learning activity that is “difficult” in the subject of “math.” The scheduling service 132 may apply the classification system to like learning activities from different courses such that a user's behavior data (collected from education application 114 by behavior service 134, and stored in behavior database 136) from one course to adaptively schedule learning activities from another course. Adaptive event scheduling based on behavior data is described in greater detail hereafter.

In one embodiment, learning server device 140 stores course information, including the learning activities and learning activity properties including their classification/s. Such course information may include a default duration for one or more learning activities. Behavior service 134 stores statistical data for other users who have completed the learning activity in one or more databases, such as behavior database 136. In one embodiment, adaptive scheduling of a learning activity comprises adjusting the default duration for the learning activity based on the user's behavior data.

### Learning Velocity Metrics

A learning velocity metric generally refers to any metric that indicates how fast a user can perform a learning activity. Thus, learning velocity metrics are typically a function of one or more of:
the duration spent on a learning activity,
an assessment of performance of a learning activity,
a classification of the learning activity, including but not limited to difficulty classifications, complexity classifications, subject matter classifications, or any other way that learning material may be classified or categorized.

For the same user, individual learning velocity metrics may be calculated for different classifications. For example, a single user may a learning velocity metric for reading easy documents, another learning velocity metric for reading hard documents, another learning velocity metric for taking math assessments, another learning velocity metric for taking history assessments, etc.

Behavior service 134 may calculate the effect of such classifications on a learning velocity metric. For example, a function for a learning velocity metric may include a coefficient that is modified based on the effect that a particular classification has on the user's performance of the learning activity.

Learning velocity metrics are merely one type of behavior data that is used by scheduling service 132 to automatically determine the scheduling of an event. Other forms of behavior data shall be described in greater detail below.

### Behavior Data

In adaptive event scheduling, scheduling server device 130 monitors and uses behavior of the user relative to one or more learning activities to adaptively schedule learning events in the user's calendar. In one embodiment, behavior service 134 monitors user data and maintains behavior data.

Table 1 includes example behavior data in accordance with one or more embodiments of adaptive event scheduling described herein. Although data is shown for one user ID, behavior service 134 may maintain behavior data may for a plurality of users. The fields of Table 1 are example fields of behavior data for individual learning activities that are used for the purpose of explanation; the behavior data, when stored as a table, may include additional fields; furthermore, one or more shown fields may be omitted for one or more learning activities.

TABLE 1
Example behavior data

| User | Course | Activity | | | Assess- | |
|---|---|---|---|---|---|---|
| ID | ID | ID | Type | Duration | ment | Date |
| 101 | ACO100 | 123 | READ | 13 min. | 95% | 10/1/14 |
| | | | | | | 9:01pm |
| 101 | ACO100 | 124 | READ | 16 min. | 90% | 10/2/2014 |
| | | | | | | 9:30pm |
| 101 | ECO101 | 131 | READ | 30 min | 60% | 10/2/2014 |
| | | | | | | 9:30pm |
| 101 | ECO101 | 133 | MATH | 30 min. | 80% | 10/3/2014 |
| | | | | | | 4:33pm |
| 101 | ACO100 | 124 | AUDIO | 20 min. | 90% | 10/4/2014 |
| | | | | | | 5:05pm |
| 101 | ECO101 | 155 | VIDEO | 10 min. | n/a | 10/4/2014 |
| | | | | | | 5:26pm |
| 101 | ECO101 | 156 | GROUP | 60 min. | n/a | 10/4/2014 |
| | | | | | | 8:00pm |

Behavior data may also refer to processed behavior data relative to performance of one or more specific learning activities, including but not limited to statistical data, learning velocity metrics, other learning coefficients, and/or behavior data comprising a behavior profile of a user.

In one embodiment, the user's behavior data includes trend information. For example, if a user is improving in a particular subject matter or other classification, then the behavior data is changed to reflect that changed. Alternatively, behavior service 134 may take trends into account simply by more heavily weighting the effect of more recent learning activities.

### Assessment Data as Behavior Data

In one embodiment, behavior service 134 processes assessment data corresponding to a user's performance of a learning activity. In one embodiment, learning server device 140 provides the assessment to education application 114, and the user takes the assessment using education application 114. The assessment provides a quantitative measure that behavior service 134 can use to modify the user's behavior profile or other behavior data. In one embodiment, the duration of an adaptively scheduled learning activity is modified based at least in part on the assessment of the performance of a prior learning activity. For example, if a user performed well on a learning activity, such as a quiz classified as advanced biology, the duration of an event corresponding to future learning activity (e.g. reading an advanced biology module or reviewing for an advanced biology exam) may be shorter. If a user performed poorly on a learning activity, the duration of an event corresponding to future learning activity may be longer. In one embodiment, additional learning activities are scheduled when a user performs poorly, such as additional study sessions and/or viewing additional educational media.

In one embodiment, scheduling service 132 suggests and/or schedules additional learning activities when a user performs poorly in an assessment. Specifically, behavior service 134, in processing the poor assessment performance, modifies the user's behavior profile to indicate that the user performed poorly given the time and/or duration of the learning activity. For example, additional learning activities may be scheduled by scheduling service 132, where the additional learning activities correspond to immediate tasks required to complete a scheduled learning activity, such as a research paper or an exam. In one embodiment, scheduling service 132 or learning server device 140 causes education application 114 to display an interactive user interface that suggests such additional learning activities. For example, if a user has a quiz scheduled for tomorrow, scheduling service 132 or learning server device 140 may cause education application 114 or another program on client device 110 do display an interface asking: “Do you want to review the prepping learning materials for the quiz tomorrow?”, “Is there a specific topic that you want to review?” and other relevant questions to determine recommended learning activities, such as specific learning materials.

In one embodiment, adaptive scheduling of a learning activity comprises determining whether a user's performance improves with respect to external event data or other external timing factors, such as a time of day the learning activity was performed, a day of week the learning activity was performed, proximity to other calendar events, or any other relation relationship between the performance of the learning activity and other calendar events (including but not limited to external calendar events). For example, if behavior service 134 detects a pattern indicating that a user is able to complete learning activities of a particular classification in a shorter duration and/or with a better assessment result in the morning, in the evening, after exercise, or on the weekend, then behavior service 134 modifies the user's behavior data accordingly. Consequently, scheduling service 132 will use the modified behavior data to schedule future learning activities, taking the detected patterns into consideration.

Capturing Behavior Data from the Target User

Behavior service 134 analyzes behavior of a user relative to one or more activities in order for scheduling service 132 to adaptively schedule future activities. In the example user behavior data of Table 1, if READ activities, e.g. reading assignments for the class ACO100 are designed to take the average user 30 minutes, but user 101 is able to consistently perform the reading assignments in half the time without performing poorly on one or more assessments, then scheduling service 132 may schedule future READ activities of class ACO100 for a shorter duration based on the behavior data, such as the actual duration spent and the assessment for the activities of this classification.

In the example user behavior data of Table 1, if READ activities, e.g. reading assignments for the class ECO101 are designed to take the average user 30 minutes, but user 101 does not perform adequately based on one or more assessments, then scheduling service 132 may modify future learning activities for the class ECO101. For example, scheduling service 132 may schedule future READ activities for a longer duration based on the behavior data, and/or scheduling service 132 may schedule additional learning activities.

### Capturing Calendar-Interaction Behavior of the Target User

In one embodiment, the user's behavior comprises detecting calendar-interaction behavior. Calendar-interaction behavior includes behavior of a user relative to events for learning activities in his electronic calendar that are automatically scheduled by scheduling server device 130. For example, calendar-interaction behavior includes changing a start time of a calendar event for a learning activity, changing a duration of the calendar event for the learning activity, or deleting a calendar event for the learning activity.

Although behavior service 134 is configured to detected calendar-interaction behavior in one embodiment, embodiments may be configured to have scheduling service 132 handle all interactions with a third party calendar server 120; in this case, the actual changes to the calendar events are detected by scheduling service 132, and may be passed on to behavior service 134 for analysis.

For example, if a user deletes a calendar event corresponding to a learning activity that is not mandatory, behavior service 134 may detect the deletion, or scheduling service 132 may detect the deletion and notify behavior service 134 of this calendar-interaction behavior. Based on this calendar-interaction behavior, behavior service 134 may change the user's behavior data to indicate that the user does not wish to complete a particular classification of event. If a user moves a calendar event, behavior service 134 may process this behavior, possibly in conjunction with other user behavior, to determine that the user does not wish to perform any learning activities (or similarly classified learning activities, depending on the user's pattern in moving the calendar events) during a certain time of day (e.g., 9 AM, mornings), time of week (e.g. Mondays, weekends), or at times relative to types of external events (e.g. any time after an event including the term “party”, immediately after an event that includes the term “exercise”). Behavior service 134 may change the user's behavior data may to indicate this determination.

For example, if a user shortens the duration of a calendar event corresponding to a learning activity, behavior service 134 may change the user's behavior data to indicate that the user wishes to spend less time on similarly classified learning activities, while if a user lengthens the duration, behavior service 134 may change the user's behavior data to indicate that the user wishes to spend more time on similarly classified learning activities.

### Scheduling Activities Based on Existing Behavior Data for the Target User

If behavior data for a user already exists, such as from a prior course, a prior learning activity of the same course, or any other prior learning activity of the user, scheduling service 132 may use such pre-existing behavior data to adaptively schedule a new learning activity. For example, when a user was previously enrolled in MATH 101 and is currently enrolled in MATH 102, behavior database 136 may include a user's profile that behavior service 134 generated based on learning activities associated with MATH 101, and scheduling service 132 may use the behavior data generated based on MATH 101 learning activities to adaptively schedule a learning activity in MATH 102.

### Scheduling Activities Based on External Event Data of the Target User

Under some circumstances, automatic scheduling may involve simply inserting the learning activities at set times, or at approximate times that do not violate any dependencies. For example, scheduling service 132 may obtain external event data from calendar server device 120 such that no learning activity is scheduled at a time that conflicts with an external event. As used herein, the term “external event” refers to an event that is not associated with a learning activity.

In one embodiment, a component of scheduling server device 130 evaluates a user's external event data to identify patterns of availability. For example, if a user consistently moves a calendar event for a learning activity and enters an overlapping external event, then behavior service 134 may infer that the user is likely busy at that time window but may not have scheduled overlapping external events in advance.

Behavior service 134 may consider other relevant factors that are external to calendar events for specific learning activities when updating a user profile, such as a total duration of scheduled learning activities in a day, a total duration of learning activities of a specific classification in a day, an amount of time between learning activities, or any other scheduling issue that may affect performance of a learning activity. Alternatively and/or in addition, scheduling service 132 may consider such other relevant factors that are external to calendar events for specific learning activities when scheduling a particular learning activity.

### Scheduling Activities Based on Behavior Data of Other Users

In one embodiment, scheduling service 134 automatically selects the duration for a first calendar event based on the statistical data for other users who have completed the first activity, i.e. historical behavior data for the activity. For example, if a user's behavior data indicates that the user completes learning activities of a certain classification slowly, then scheduling service 132 may schedule, a particular learning activity of that classification, a duration that is longer than a default duration for that activity. Likewise, scheduling service 132 may schedule a longer duration if the user's behavior data indicates that the user performs poorly on assessments of learning activities of that classification. In one embodiment, a particular learning activity is associated with a default duration, and the behavior data of the user, such as a behavior profile and/or one or more learning velocity metrics, is used to adjust the duration of the particular learning activity for the user. The default duration may be based on the duration and/or the performance of historical users for the learning activity. For example, if a user completes a learning activity in less time than the default duration and performs well on an assessment, scheduling service 132 may schedule future learning activities of the same category for a shorter period than the default duration. In one embodiment, the change in duration may require changing the start time of the learning activity, such as when the change in duration is an increase that causes a conflict with another calendar event in the user's electronic calendar.

### Linking an Activity to a Calendar Event

Once scheduling service 132 has determined a start time and duration for a learning activity for the user of client device 110, scheduling service 132 automatically causes a corresponding event to be added to that user's calendar. In one embodiment, scheduling service 132 adds the event by communicating with calendar server device 120 via one or more Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication.

In one embodiment, the calendar event that is inserted into the target user's calendar has a link to launch the activity associated with the calendar event. For example, if the activity involves reading a document, the calendar entry may include a link that, when activated by the target user, opens the document. Just as different activities require different resources, activating the links associated with different activities may launch different resources. For example, activating a link embedded in a calendar event may launch a video player and load a particular video, launch an audio player and load a particular audio, or launch an application, which may be a mobile application, a web application, or any other computer application.

In one embodiment, the link that is embedded in the event associated with an activity comprises metadata that includes all the data necessary to allow the target user to participate in the activity. Thus, the link may link back into a learning platform, such as the learning platform provided by learning server device 140.

In one embodiment, the calendar event for a learning activity includes a deep link that opens a specific document and/or an a specific application, such as a mobile application, a web application, or any other computer application. Deep linking refers to the use of a hyperlink to refer to specific content, such as a particular piece of web content hosted by a website, as opposed to a general landing page.

Deep linking is implemented by including metadata in the deep link, which is stored in the calendar event. In one embodiment, the link comprises metadata that is inserted into the calendar event that is configured to drive traffic back to a learning application, including a mobile application, a web application, or any other computer application. The learning application may automatically display or otherwise provide the learning activity and/or monitor performance of the learning activity. In one embodiment, the electronic calendar acts as an entry point directly into the learning application, and may act as an entry point to specific learning activities within a user's account in the learning application. In one embodiment, the learning application tracks the duration that the user interacts with a particular learning activity, and may display a timer in the learning interface for the user.

In one embodiment, the metadata inserted in the calendar event comprises all the data necessary to authorize a link back into a learning platform for a particular user and/or learning activity, such as a learning server device and/or an application communicatively coupled with a learning server device. In this manner, a user that is viewing his personal electronic calendar may use the link to directly access the learning activity and connect to the learning platform, which recognizes the user as a specific authorized user.

In one embodiment, the metadata associated with a calendar event for a learning activity comprises all of the necessary launch data to authorize an interactive learning session and to link to materials and/or data specific to the user and/or the corresponding learning activity. The launch data may include, for example, context and authentication information, such as an access token. The context and authentication information enables the deep link to directly bring the user to the corresponding learning activity in the learning application, such as education application 114. In the following example, the context and authentication information are provided in the link that is included in the calendar event:

Platform[app id]://authorize#expires_in=0&access_token=[TOKEN]

&target_url=[ACTIVITY_URL]&user=[USER_ID]&activityId=[ACTIVITY_ID]
&courseId=[COURSE_ID]

In one embodiment, the metadata is used to generate a deep link to a learning application, such as education application 114, wherein the deep link causes the learning application to present material associated with one or more learning activities of an online course, such as but not limited to interactive course materials. An online course is a course that includes at least one learning activity that is conducted over a network, such as the Internet. In one embodiment, the application is configured to monitor the behavior of the user relative to the performance of the corresponding activity, and the behavior is used to schedule calendar events for future activities.

In one embodiment, one or more cookies, plugins and/or extensions are provided to the user's device, such as but not limited to the user's web browser. These cookies, plugins and/or extensions are embedded and configured to communicate with the learning platform. The cookies, plugins and/or extensions may use the metadata contained in a calendar event for a learning activity, such as XML metadata, to laundry and authorize a session with the user to perform the learning activity.

### Changing Scheduled Learning Activities Based on Updated Behavior Data

In one embodiment, after behavior service 134 makes changes to a user's behavior data, such as a behavior profile, scheduling service 132 re-evaluates the scheduling of learning activities that were previously scheduled by scheduling service 132 but not yet completed. In one embodiment, scheduling service 132 adaptively reschedules such learning activities based on the change in the user's behavior data. For example, after changing a user's behavior profile and/or behavior data, behavior service 134 can notify scheduling service 132 that one or more changes have been made thereto. Scheduling service 132 may handle such notifications selectively. For example, if a change affects only learning activities of a certain classification, such as cellular biology, then only scheduled learning activities classified as “cellular biology” will be considered candidates for rescheduling. Likewise, if a change affects only calendar events that correspond to specific external data (e.g. “Mondays at 9 PM”), then only scheduled learning activities that correspond to the specific external data will be considered candidates for rescheduling.

### Example Process for Adaptive Event Scheduling

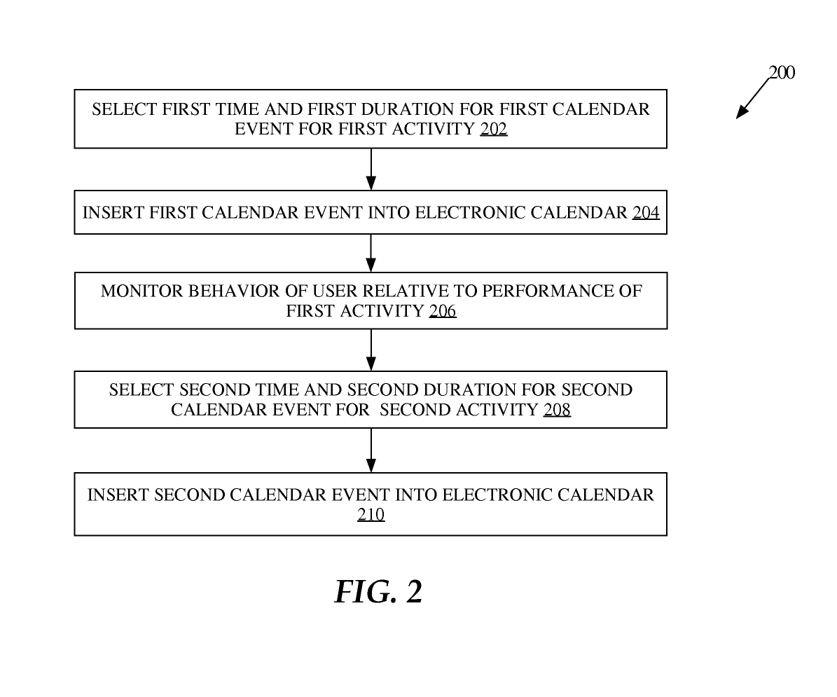

FIG. 2 is a flow diagram that illustrates an embodiment of a process for adaptive event scheduling for related activities. Process 200 is performed by one or more computing devices and/or processes thereof. For example, one or more blocks of process 200 is performed by computer system 400.

In one embodiment, a user corresponding to client device 110 is enrolled in a course that includes a set of learning activities, which may be categorized and which may have dependencies on each other. Scheduling server device 130 performs process 200 to add at least a portion of the set of learning activities to the user's electronic calendar.

At block 202, scheduling service 132 selects a first start time and a first duration for a first calendar event corresponding to a first activity of the course. In one embodiment, the first start time and the first duration are selected by scheduling service 132. For the purpose of explanation, it shall be assumed that the first activity is a reading assignment, which is the first learning activity of the course. Scheduling server 132 may automatically select the first start time and the first duration based on one or more factors corresponding to the first activity, including but not limited to a course schedule (obtained from learning server device 140), other course data (obtained from learning servicer device 140), time availability of the user (obtained from calendar server device 120), and statistical data for other users who have completed the first activity (obtained from behavior service 134).

At block 204, scheduling service 132 causes insertion of the first calendar event into the electronic calendar of the target user at the first start time and with the first duration. In one embodiment, block 204 is performed by causing insertion of the first calendar event into the electronic calendar associated with the user, such as by sending instructions to calendar server device 120 over a network 150. As explained above, the first calendar event may have a link that comprises all of the launch data necessary to authorize a link back into a learning platform for the target user to participate in the learning activity associated with the first calendar event.

At block 206, behavior of the user is monitored relative to performance of the first activity. In one embodiment, an application, such as education application 114, monitors the behavior of the user relative to the performance of the first activity. Alternatively and/or in addition, behavior service 134 monitors the behavior of the user. For example, behavior service 134 may communicate with a client-side application such as education application 114 to receive behavior data. In one embodiment, monitoring the behavior of the user comprises determining one or more of a time that the link to the first activity is activated, an actual start time, an actual duration, a reading rate, a comprehension level, an assessment, or another factor relative to the performance of the first activity by the user. In one embodiment, monitoring performance of the first activity further comprises determining one or more external timing factors relative to the performance of the first activity by the user. In one embodiment, the monitored user behavior is stored in a manner that is accessible to scheduling service 132, such as in behavior database 136.

At block 208, scheduling service 132 selects a second start time and a second duration for a second calendar event for a second activity based, at least in part, on the behavior of the user relative to performance of the first learning activity. In one embodiment, the second start time and the second duration are selected by scheduling service 132. In one embodiment, the second calendar event is for a second learning activity. The second learning activity may belong to the same course as the first learning activity, or to a different course. In one embodiment, the selection of the second start time and the second duration is based on one or more additional factors including but not limited to an actual start time, an actual duration, a reading rate, a comprehension level, an assessment, or another factor relative to the performance of the first activity by the user. In one embodiment, monitoring performance of the first activity further comprises determining one or more external timing factors relative to the performance of the first activity by the user. In one embodiment, the second start time and the second duration are selected based on a learning velocity metric calculated based on one or more of these factors. Additionally, scheduling service 132 may select the second start time and/or the second duration based on one or more activity property factors corresponding to second activity such as but not limited to a course schedule, other course data, time availability of the user, and statistical data for other users who have completed the second activity. In one embodiment, the second learning activity is already scheduled at an existing start time and for an additional duration, and selecting the second start time and the second duration comprises determining at least one of a new start time and a new duration for the second activity.

At block 210, scheduling service 132 cause insertion of the second calendar event into the electronic calendar at the second start time and with the second duration. In one embodiment, block 210 is performed by causing insertion of the second calendar event into the electronic calendar associated with the user, such as by sending instructions to a calendar server device 120 over a network. In one embodiment, causing insertion of the second calendar event into the electronic calendar comprises changing at least one of an existing start time and an existing duration of an existing calendar event for the second activity, or inserting a new calendar event for the second activity and deleting the existing calendar event for the second activity.

### Example Process for Maintaining and Using a Behavior Profile

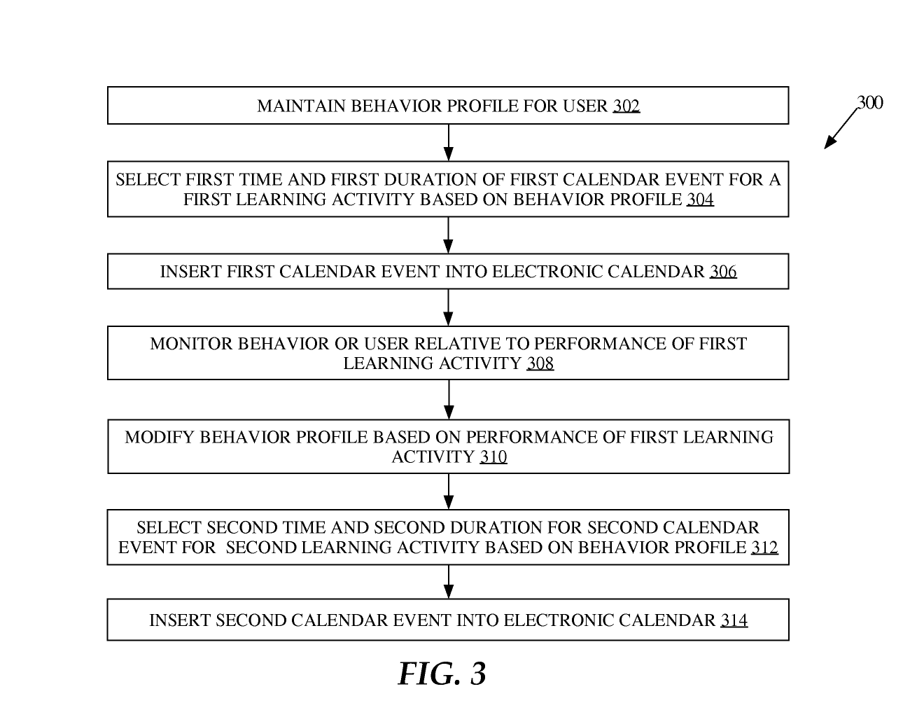

FIG. 3 is a flow diagram that illustrates an embodiment of a process for maintaining a behavior profile and using the behavior profile for adaptive event scheduling for related learning activities. Process 300 is performed by one or more computing devices and/or processes thereof. For example, one or more blocks of process 300 is performed by computer system 500.

At block 302, behavior service 134 maintains a behavior profile for a user. The behavior profile comprises the user's behavior data for a plurality of courses. The plurality of courses may include one or more current courses that the user is enrolled in and/or one or more previous courses that the user has completed. The behavior profile includes behavior data pertaining to learning activities for the plurality of courses. The behavior profile may include one or more learning velocity metrics, which may be based on additional factors such as classifications of the learning activities and external timing categories. In one embodiment, behavior service 134 maintains a behavior profile that is stored in behavior database 136.

At block 304, scheduling service 132 selects a first start time and a first duration for a first calendar event for a first learning activity. Scheduling service 132 selects at least one of the first start time and the first duration based, at least in part, on the behavior profile of the user. Scheduling service 132 may select at least one of the first start time and the first duration further based on one or more factors corresponding to first learning activity including but not limited to a course schedule, other course data, time availability of the user, and statistical data for other users who have completed the first learning activity. In one embodiment, the first start time and the first duration are selected by a service of a scheduling server device, such as scheduling service 132 of scheduling service 132.

At block 306, scheduling service 132 causes insertion of the first calendar event into an electronic calendar associated with the user at the first start time and with the first duration. The electronic calendar is associated with a user. In one embodiment, block 306 is performed by causing insertion of the first calendar event into the electronic calendar associated with the user, such as by sending instructions to a calendar server device 120 over a network 150.

At block 308, behavior service 134 monitors the behavior of the user relative to performance of the first learning activity. In one embodiment, the first calendar event comprises a link to the first learning activity that opens a document and/or an application, such as education application 114. In one embodiment, behavior service 134 monitors the behavior of the user relative to the performance of the first learning activity via education application 114. In one embodiment, monitoring the behavior of the user comprises determining one or more of a time that a link to the first learning activity is activated, an actual start time, an actual duration, a reading rate, a comprehension level, an assessment, or another factor relative to the performance of the first learning activity by the user. In one embodiment, monitoring performance of the first learning activity further comprises determining one or more external timing factors relative to the performance of the first learning activity by the user.

At block 310, behavior service 134 modifies the behavior profile of the user based on the behavior of the user relative to performance of the first learning activity. In one embodiment, the behavior profile is modified by behavior service 134, and the modified behavior profile is stored in behavior database 136. In one embodiment, one or more learning velocity metrics are added to the user's behavior profile or modified in the user's behavior profile based on the user's performance of the first learning activity. In one embodiment, a learning velocity metric is a function of one or more of the duration spent on a learning activity, an assessment of performance of a learning activity, and/or a classification of the learning activity, including but not limited to difficulty classifications, complexity classifications, subject matter classifications, or other classifications. In one embodiment, one or more learning velocity metrics are further based on external timing factors that are based on timing information external to the learning activity itself, such as a time of day the learning activity was performed, a day of week the learning activity was performed, and other calendar events.

At block 312, scheduling service 132 selects a second start time and a second duration for a second calendar event for a second learning activity based, at least in part, behavior data generated based on the behavior of the user relative to performance of the first learning activity, such as but not limited to a behavior profile of the user that has been modified based on the behavior of the user relative to performance of the first learning activity. In one embodiment, the second start time and the second duration are selected by a service of a scheduling server device, such as scheduling service 132 of scheduling service 132. In one embodiment, the second calendar event is for a second learning activity of a course. The second learning activity may belong to the same course as the first learning activity or a different course from the first learning activity. In one embodiment, the selection of the second start time and the second duration is based on one or more activity property factors corresponding to second activity such as but not limited to a course schedule, other course data, time availability of the user, and statistical data for other users who have completed the second activity. In one embodiment, the second learning activity is already scheduled at an existing start time and for an additional duration, and selecting the second start time and the second duration comprises determining at least one of a new start time and a new duration for the second learning activity.

At block 314, scheduling service 132 cause insertion of the second calendar event into the electronic calendar at the second start time and with the second duration. In one embodiment, block 316 is performed by causing insertion of the second calendar event into the electronic calendar associated with the user, such as by sending instructions to a calendar server device 120 over a network. In one embodiment, causing insertion of the second calendar event into the electronic calendar comprises changing at least one of an existing start time and an existing duration of an existing calendar event for the second learning activity, or inserting a new calendar event for the second learning activity and deleting the existing calendar event for the second learning activity.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

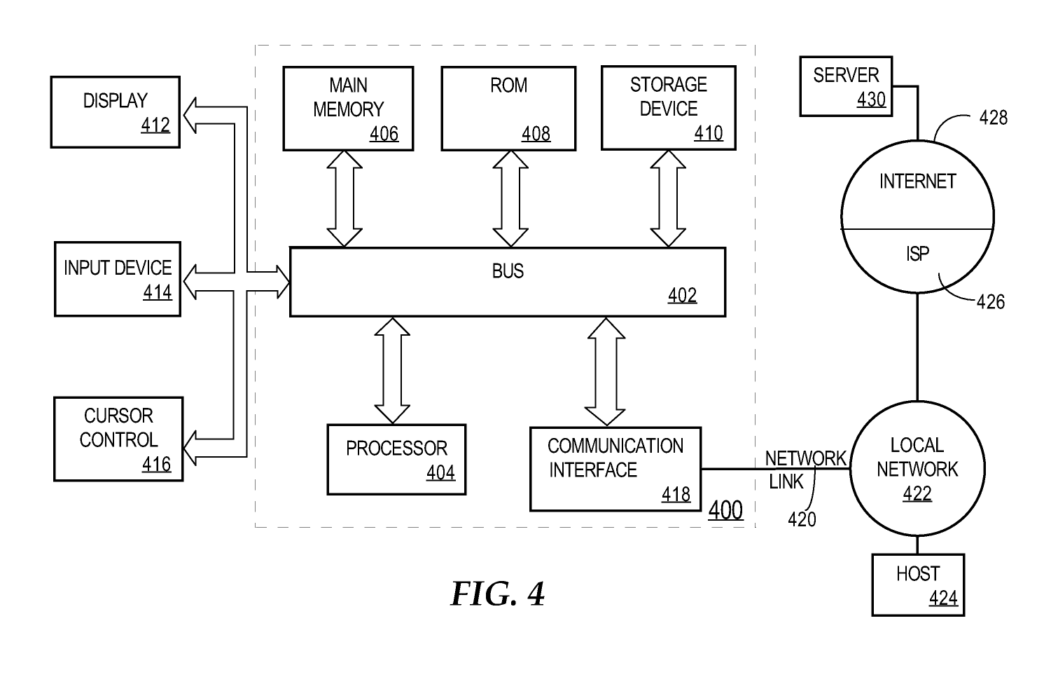

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
automatically selecting a first start time and a first duration for a first calendar event;
causing insertion of the first calendar event, at the first start time and with the first duration, into an electronic calendar associated with a user that is participating in a course;
wherein the first calendar event is for a first learning activity of the course;
monitoring behavior of the user relative to performance of the first learning activity;
based, at least in part, on the behavior of the user relative to performance of the first learning activity, automatically selecting a second start time and a second duration for a second calendar event;
causing insertion of the second calendar event, at the second start time and with the second duration, into the electronic calendar;
wherein the second calendar event is for a second learning activity of the course;
wherein the method is performed by one or more computing devices.

2. The method of claim 1, wherein the first calendar event comprises a link to the first activity.

3. The method of claim 1,
wherein monitoring the behavior of the user relative to the performance of the first learning activity comprises determining an actual time of the performance of the first learning activity;
wherein the second time is based, at least in part, on the actual time.

4. The method of claim 1,
wherein monitoring the behavior of the user relative to the performance of the first learning activity comprises determining an actual duration of the performance of the first learning activity;
wherein the second duration is based, at least in part, on the actual duration.

5. The method of claim 1,
wherein monitoring the behavior of the user relative to the performance of the first learning activity comprises performing an assessment of the performance of the first learning activity;
wherein the second duration is based, at least in part, on the assessment of the performance of the first learning activity.

6. The method of claim 1,
wherein the second calendar event is in the electronic calendar at a prior start time and has a prior duration;
wherein causing insertion of the second calendar event at the second start time and with the second duration comprises changing at least one of the prior start time and the prior duration.

7. The method of claim 1, further comprising:
based, at least in part, on the behavior of the user relative to performance of the first learning activity, automatically selecting a third start time and a third duration for a third calendar event;
causing insertion of the third calendar event, at the third start time and with the third duration, into the electronic calendar;
wherein the third calendar event is for a learning activity of a second course,
wherein the user is associated with the second course,

8. The method of claim 1, wherein automatically selecting the second start time and the second duration for the second calendar event is further based on schedule data associated with the course.

9. The method of claim 1, wherein automatically selecting the first start time and the first duration for the first calendar event is further based on historical behavior data of a plurality of other users relative to the performance of the first learning activity.

10. The method of claim 1, further comprising:
maintaining a behavior profile for the user, the behavior profile comprising user data for a plurality of courses;
wherein automatically selecting the first start time and the first duration for the first calendar event is based, at least in part, on the behavior profile;
modifying the behavior profile of the user based on the behavior of the user relative to performance of the first learning activity;
wherein automatically selecting the second start time and the second duration for the second calendar event is based, at least in part, on the modified behavior profile.

11. A non-transitory computer-readable medium storing instructions which, when executed by one or more processors, cause the one or more processors to perform:
automatically selecting a first start time and a first duration for a first calendar event;
causing insertion of the first calendar event, at the first start time and with the first duration, into an electronic calendar associated with a user that is participating in a course;
wherein the first calendar event is for a first learning activity of the course;
monitoring behavior of the user relative to performance of the first learning activity;
based, at least in part, on the behavior of the user relative to performance of the first learning activity, automatically selecting a second start time and a second duration for a second calendar event;
causing insertion of the second calendar event, at the second start time and with the second duration, into the electronic calendar;
wherein the second calendar event is for a second learning activity of the course.

12. The non-transitory computer-readable medium of claim 11, wherein the first calendar event comprises a link to the first activity.

13. The non-transitory computer-readable medium of claim 11,
wherein monitoring the behavior of the user relative to the performance of the first learning activity comprises determining an actual time of the performance of the first learning activity;
wherein the second time is based, at least in part, on the actual time.

14. The non-transitory computer-readable medium of claim 11,
wherein monitoring the behavior of the user relative to the performance of the first learning activity comprises determining an actual duration of the performance of the first learning activity;
wherein the second duration is based, at least in part, on the actual duration.

15. The non-transitory computer-readable medium of claim 11,
wherein monitoring the behavior of the user relative to the performance of the first learning activity comprises performing an assessment of the performance of the first learning activity;
wherein the second duration is based, at least in part, on the assessment of the performance of the first learning activity.

16. The non-transitory computer-readable medium of claim 11,
wherein the second calendar event is in the electronic calendar at a prior start time and has a prior duration;
wherein causing insertion of the second calendar event at the second start time and with the second duration comprises changing at least one of the prior start time and the prior duration.

17. The non-transitory computer-readable medium of claim 11, the instructions further comprising instructions that cause the one or more processors to perform:
based, at least in part, on the behavior of the user relative to performance of the first learning activity, automatically selecting a third start time and a third duration for a third calendar event;
causing insertion of the third calendar event, at the third start time and with the third duration, into the electronic calendar;
wherein the third calendar event is for a learning activity of a second course,
wherein the user is associated with the second course,

18. The non-transitory computer-readable medium of claim 11, wherein automatically selecting the second start time and the second duration for the second calendar event is further based on schedule data associated with the course.

19. The non-transitory computer-readable medium of claim 11, wherein automatically selecting the first start time and the first duration for the first calendar event is further based on historical behavior data of a plurality of other users relative to the performance of the first learning activity.

20. The non-transitory computer-readable medium of claim 11, the instructions further comprising instructions that cause the one or more processors to perform:
maintaining a behavior profile for the user, the behavior profile comprising user data for a plurality of courses;
wherein automatically selecting the first start time and the first duration for the first calendar event is based, at least in part, on the behavior profile;
modifying the behavior profile of the user based on the behavior of the user relative to performance of the first learning activity;
wherein automatically selecting the second start time and the second duration for the second calendar event is based, at least in part, on the modified behavior profile.
